(19) United States
(12) Patent Application Publication
(10) Pub. No.: US 2024/0400428 A1
(43) Pub. Date: Dec. 5, 2024

(54) VENTILATED MAT SYSTEM AND PROCESSES

(71) Applicant: David A. Potts, Lyme, CT (US)

(72) Inventor: David A. Potts, Lyme, CT (US)

(21) Appl. No.: 18/205,955

(22) Filed: Jun. 5, 2023

(51) Int. Cl. C02F 3/04

(52) U.S. Cl. CPC C02F 3/046; C02F 2203/006

(57) ABSTRACT

Applied loads to the soil or material directly above the water treatment system components may be managed in embodiments so as to not exceed a maximum value similar to that imposed by walking, riding mowers, pedestrian traffic, or other lower load values. Managing the applied loads to soil or other material above a water infiltration field or other water treatment component serve to reduce or eliminate soil compaction and thereby maintain air flow through the soil and to and from the underlying water treatment system components. When footers are used and located outside of the water treatment system components, the imposed soil loads may be higher as soil compaction in areas not above the water treatment system may not be needed for proper air flow to and from the infiltration field or other water treatment system component. When slab-on-grade type configurations are used, the imposed soil loads may be managed above the water treatment components so as to have minimal soil compaction to maintain proper air flow to and from the infiltration field or other water treatment system component.

### TECHNICAL FIELD

One or more ventilated mats are described for placement over components of a water infiltration system. More specifically, ventilated mats comprising a plurality of passages suitable for the passage of gas or vapor, including water vapor, through the mat and towards, or from, underlying components of a water infiltration system are provided herein.

### BACKGROUND

Water having various sources including wastewater, including but not limited to septic, storm water, and process water (all of which may herein be collectively referred to as “water”) may be treated via an infiltration system of a water treatment system. Water treatment systems can vary in size and scope. They can be sized for treatment of large amounts of water from a municipality or other large cumulative systems for benefitting many residences, businesses, and industrial facilities serviced by the municipality. Infiltration systems and the water treatment systems they can be a part of, can also be designed and sized for single-home residential use and small-scale residential and commercial uses.

In the various applications, a water treatment system will often include one or more infiltration fields. These infiltration fields often receive water from an upstream source such as a treatment vessel and pass the water to surrounding soil via infiltration. The water is treated as it passes through the infiltration field and into the surrounding soil. The infiltration field can include water channels that receive the water and pass it to the surrounding soil. The channels can have various shapes including being large open galleys as well as smaller rectangular flow channels. When water is not evenly distributed in an infiltration field to the channels some channels accumulate water and become overloaded while other channels of the infiltration field receive less water and/or become or remain dry. In overloaded channel/dry channel instances, an infiltration field is not performing at its maximum throughput.

Air passage from above to subsurface infiltration fields can serve to promote treatment of the water moving through an infiltration field. Accordingly, subsurface infiltration fields are regularly covered with grass or soil or other air ventilated covering. Portions of infiltration fields underlying a stone, gravel, asphalt or concrete surface are deemed to inhibit performance of infiltration fields.

Embodiments may be directed to various mats or overlying structures that can be positioned above an infiltration field and permit the infiltration field to receive air, transfer vapors and gases and therefore, treat and infiltrate at the same or similar levels to a system covered by grass and the like.

### BRIEF DESCRIPTION OF THE DRAWINGS

FIG. 1A provides a top view schematic of a ventilated mat system, the ventilated mat system with a plurality of passages therethrough, the ventilated mat system positioned atop of dosing conduits of a subsurface infiltration field of a water treatment system, as may be employed in some embodiments.

FIG. 1B provides a sectional side view along line 1B-1B of the ventilated mat system of FIG. 1A as may be employed in some embodiments.

FIG. 1C provides a sectional side view of exemplary passage configurations as may be employed in ventilated mat systems of some embodiments.

FIG. 2 provides a top view schematic of a ventilated mat system, the ventilated mat system with a plurality of passages therethrough, the ventilated mat system positioned atop of dosing conduits of a subsurface infiltration field of a water treatment system as may be employed in some embodiments.

FIG. 3 provides a sectional side view along line 3-3 of the ventilated mat system of FIG. 2, with underlying dosing conduits, as may be employed in some embodiments.

FIG. 4 provides a sectional side view along line 4-4 of the ventilated mat system of FIG. 2, with underlying dosing conduits, as may be employed in some embodiments.

FIG. 5 provides a side view of a ventilated mat system, with underlying footings, as may be employed in some embodiments.

FIG. 6 provides a side view of a ventilated mat system, with underlying infiltration field, as may be employed in some embodiments.

FIG. 7A provides a side view of a ventilated mat system with perimeter footings, the ventilated mat system positioned above dosing conduits and treatment media, as may be employed in some embodiments.

FIG. 7B is a top view of the ventilated mat system of FIG. 7A, as may be employed in some embodiments.

FIG. 8A provides a side view of a ventilated mat system with multiple footings, the ventilated mat system positioned above dosing conduits and treatment media, as may be employed in some embodiments.

FIG. 8B is a top view of the ventilated mat system of FIG. 8A, as may be employed in some embodiments.

FIG. 9 provides multiple side views of ventilated mat systems, as may be employed in some embodiments.

FIG. 10A provides a top view schematic of a ventilated mat system, the ventilated mat system with a plurality of passages therethrough, the ventilated mat system positioned atop dosing conduits of a subsurface infiltration field of a water treatment system, as may be employed in some embodiments.

FIG. 10B provides a side of the ventilated mat system of FIG. 10A, with underlying dosing conduits, as may be employed in some embodiments.

FIG. 11 provides various linking configurations for adjacent individual ventilated mats of a ventilated mat system, as may be employed in some embodiments.

FIG. 12A provides a top view of a ventilated mat form system, as may be employed in some embodiments.

FIG. 12B provides a side view of the ventilated mat form system of FIG. 12A, as may be employed in some embodiments.

FIG. 13A provides a top view of a ventilated mat system with elongated rails, as may be employed in some embodiments. FIG. 13B provides a first side view of the ventilated mat system of FIG. 13A, as may be employed in some embodiments. FIG. 13C provides a second side view of the ventilated mat system of FIG. 13A, as may be employed in some embodiments.

FIG. 14 provides a process chart with process features, as may be employed in some embodiments.

### DETAILED DESCRIPTION

This disclosure provides systems, processes, apparatus, and articles of manufacture that may be configured, designed, manufactured, transported, installed or operated to subsequently provide a ventilated mat positioned over an infiltration field or other components of a water treatment system. A ventilated mat of embodiments can be suitable to accommodate certain vehicular loading received by the ventilated mat and to transfer reduced loading to certain areas below the ventilated mat; without diminishing gas and vapor transfer, characteristic of systems in typical settings with grass and other similar plant coverings, not subject to wheel loads. Embodiments, may receive live vehicular loads and mitigate those loads such that imposed loads below the ventilation mat over or around wastewater treatment system components is reduced. These reduced loads may be targeted to diminish or eliminate soil compaction below certain portions of a ventilated mat and above portions of a wastewater treatment system. By reducing soil compaction in these targeted areas infiltration fields or other areas of a wastewater treatment system benefitted by gas or vapor transfer operating with surrounding soil as if the above imposed loads were less or non-existent. Thus, ventilated mats may be employed in applications where soil compaction had previously served to limit or prohibit vehicular traffic and the deleterious effect of soil compaction.

Applied loads to the soil or material directly above the water treatment system components may be managed in embodiments so as to not exceed a maximum value similar to that imposed by walking, riding mowers, pedestrian traffic, or other lower load values. Managing the applied loads to soil or other material above a water infiltration field or other water treatment component serve to reduce or eliminate soil compaction and thereby maintain air and vapor flow through the soil and to and from the underlying water treatment system components. When footers are used and located outside of the water treatment system components, the imposed soil loads may be higher as soil compaction in areas not above the water treatment system may not be needed for proper air and vapor flow to and from the infiltration field or other water treatment system component. When slab on grade type configurations are used, the imposed soil loads may be managed above the water treatment components so as to have minimal soil compaction to maintain proper air and vapor flow to and from the infiltration field or other water treatment system component.

Ventilated mat systems of embodiments may comprise one or more mats with the mats having a plurality of passages therethrough. The passages and any material present in the passages permit the transfer of air, gas or vapor (gas) from above and below the mat. Water held by capillary action inhibits the transfer of air, gas, and vapor. Accordingly, passage geometry, e.g., passage shape, and the presence of any fill material in such passages, is designed to inhibit capillary water retention in ventilated mats. For example, e.g., ⅜ stone-¾ stone present in a passage does not have sufficient capillary to inhibit the transfer of air, gas, or vapor. Comparatively, a silty soil present in a passage can develop unwanted capillary thereby retaining sufficient water to inhibit the transfer of air, gas or vapor through the system.

The mats may be configured to reduce or eliminate underlying soil compaction. These soil compaction results may be accomplished by broadly distributing vehicular axle or tire loads. This broad distribution may be accomplished by various designs shown herein as well as by teachings of this application. These soil compaction results may be accomplished by transferring vehicular axle or tire loads to footers located away from water treatment system components. In these footer instances soil compaction below the footers may be higher than any compaction experienced between spans of a ventilating mat between the footers. By providing passages through the ventilated mat and by reducing surface live loading, gas or vapor may reach an infiltration field or other component of a water treatment system in a manner consistent with not having an overlying ventilated mat, yet with the ability to support vehicular loads over the water treatment system.

A ventilated mat system of embodiments may comprise a single mat as well as multiple mats positioned near or adjacent to each other. Adjacent mats may be joined with various locking configurations serving to maintain proximity of joined mats. The mats may comprise various materials, including concrete, pre-cast concrete, polymers, ceramics, composite materials, wood, steel, carbon fiber reinforced composite materials, reinforced concrete, reinforced pre-cast concrete, combinations thereof, and other materials as well. The mats may be manufactured on site as well as premanufactured and brought to a site for subsequent installation. The mats of a ventilated mat system may comprise footings, may have various cross-sectional configurations, may be considered slab constructions, may be considered slab-on-grade constructions, and may have other configurations as well. Embodiments of mat systems may be configured such that soil compaction below the mat system is minimized so as to retain air and vapor flow therethrough. Embodiments of mat systems may be configured such that imposed live loads placed on exposed surfaces of the mat system are reduced to lower values when transferred from non-footing bottom areas of the mat system. For example, a mat system configured as a slab-on-grade may have a thickness and a rigidity such that live loads of 40 PSI imposed by a moving or stationary vehicle on the mat system are reduced to 11.0 PSI, 8.0, PSI, 5.0 PSI, or 3.0 PSI, or 1.5 PSI on a lower subsurface area below the mat. As another example, a mat system configured with multiple footings and slabs supported by these footings may have a slab thickness, a slab rigidity, and footing configurations and placements such that live loads of 40 PSI imposed by a moving or stationary vehicle on the mat system are reduced to 11.0 PSI, 8.0 PSI, 5.0 PSI, or 3.0 PSI, or 1.5 PSI on a lower surface of the slab portions of the mat system opposite the load receiving surfaces of the mat system. In each example, soil compaction can be minimized from surface live loading and air passage to underlying infiltration fields can be maintained or otherwise supported. Thus, by providing support to imposed live loads, a mat system may reduce soil compaction and may itself have a plurality of passages to allow air to pass through the mat and pass through the soil beneath the mat in order to reach an underlying water treatment system component or components.

An ability to support vehicular loading may enable infiltration fields or other components of a water treatment system to be installed underneath ventilated mat systems where the overlying mat may serve as, or support, vehicular roads, vehicular driveways, vehicular parking lots, or other vehicular surface applications. In so doing, embodiments may provide for the installation of infiltration fields or other water treatment system components to be installed in locations previously deemed impermissible.

Ventilated mat systems of embodiments may be configured to support vehicular wheel loading—both static and/or rolling vehicular loading in embodiments. Exemplary vehicular loading supported by ventilated mat systems may comprise H-10 AASHTO (American Association of State Highway and Transportation Officials) wheel loading standards, H-20 AASHTO wheel loading standards, and other suitable standards. Specific wheel loading may comprise 20, 32, 45, 65, 75, and 85 PSI as well as other imposed wheel load pressures above and below these values, where loading may be provided by noncommercial and commercial vehicles that may sit upon or travel over a ventilated mat system.

Embodiments may comprise steel plates with a plurality of passages therethrough to provide for air or vapor passage. Ventilated mat systems may comprise features of a floating slab/slab-on-grade. In such configurations, a mat of a ventilated mat system may be supported along its bottom surface from underlying material and may have few if any footings. In such floating slab/slab-on-grade configurations, vehicular load may be transferred through the ventilated mat system downward and to underlying material. Deflection of the ventilated mat system during loading and distribution of the loading downward and to underlying material may be accommodated by the thickness of the ventilated mat system, by the materials of the ventilated mat system, by the configuration of the ventilated mat system, by combinations of these or other features of the ventilated mat system. Ventilated mat systems may also employ footings to manage loading transfer or for other reasons. These footings may be located along a perimeter of a ventilated mat system, may be located in internal locations within a perimeter of a ventilated mat system, and/or in various combinations thereof. Ventilated mat systems may be configured to carry loads and transfer these loads to footings of the ventilated mat system. In embodiments, reinforcement, cross-sectional shape, composite material orientation, as well as other configurations may be used to design ventilated mat systems rigid enough to support vehicular loading while not necessarily also receiving uniform underlying support from an underlying material as would be experienced by a floating slab/slab-on-grade type design. In these “bridge” type configurations, where non uniform loading is applied to underlying material by a ventilated mat system, footings may apply loading underlying materials while the spans between footings may be configured to carry the anticipated vehicular loading with acceptable deflection and to transfer this loading, through the footings, to the desired regions of the underlying materials.

In embodiments, ventilated mat systems, with or without footings, may be configured such that soil compaction above infiltration fields or other water treatment system components is marginalized. Soil above infiltration fields or other water treatment system components and below ventilated mat systems may receive reduced loading from live loads placed on the ventilated mat systems. This reduction in transfer of live loads may be accomplished by the configuration of the ventilated mat system. In some instances, it may be suitable to have a thickness, rigidity, and size of a floating mat configuration that transfers acceptable values of live loads downwards to soil directly above water treatment system components. Acceptable values may comprise 1.5, 3.0, 5.0, 8.0, 10.0 and 11.0 PSIs below the ventilated mat systems and above/received by underlying water treatment system components. These PSI values may correspond to imposed direct live loads above an infiltration field without a ventilation mat from: pedestrian traffic or landscaping equipment (e.g., mowers, utility vehicles, etc.). In some instances, footings may be employed to reduce loading in certain areas below the ventilated mat and transferring these live loads to areas not atop water treatment system components.

In certain embodiments a ventilated mat system may have no overlying soil or other material. Embodiments may be configured to reduce or prevent compaction of material below the ventilated mat system as compaction can diminish or eliminate effectiveness of gas transfer in and around the infiltration field or other water treatment system components. Embodiments include utilizing ventilated aggregates above the system to maintain porosity and provide for a uniform surface. Examples would include placing stone, as is typically utilized in driveways, over the ventilated matting. The ratio of passage area to total surface square footage of a ventilated mat system may be 25%-50% or more or less. For example, if a ventilated mat system was one-hundred square feet in area (e.g., 10′×10′), the cumulative exposed surface area of all the passages at the top surface of the ventilated mat system may be on the order of twenty-five square feet to fifty square feet or more or less.

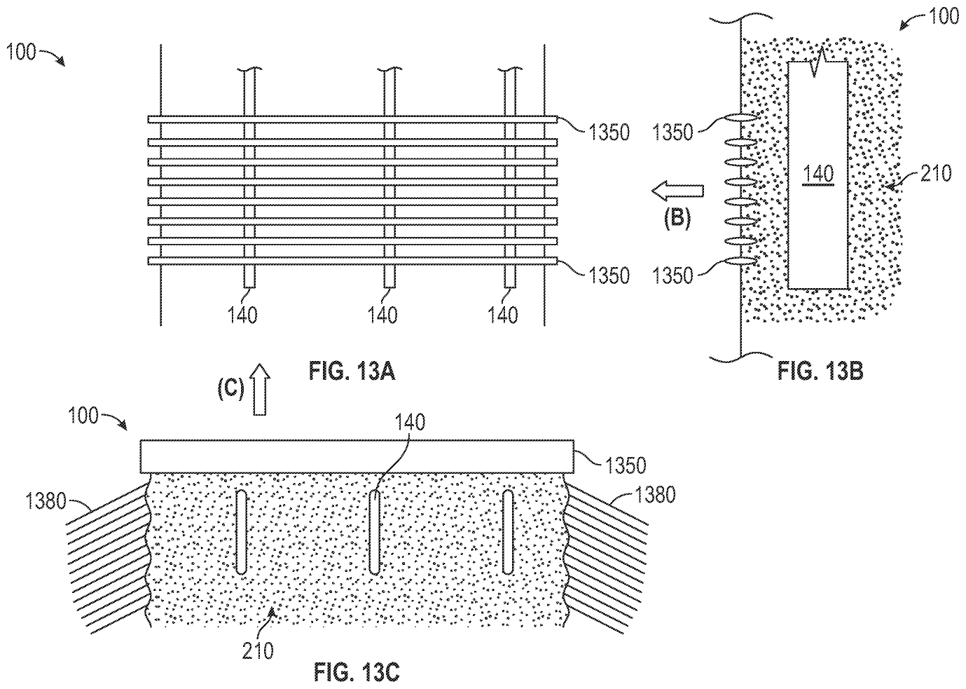

Ventilated mat systems may comprise numerous individual mats that are linked together. These individual mats may be narrow or shorter than the entire ventilated mat system. These smaller sizes may provide for easier handling of the individual mats prior to or during installation. In embodiments, individual mats may be on the order of two-foot wide or four-foot wide sections (or other widths) having lengths of ten feet or other lengths. Several mats may be linked together to form, for instance, a larger ten foot by ten foot ventilated mat system overlying an infiltration field or other water treatment system component. If still more individual mats are linked together, a larger still ventilated mat may be formed, e.g., ten feet by fifty feet, or ten feet by one-hundred feet, etc. In some instances, the individual mats may be linked on their narrow sides to create other dimensions as well. For instance, twenty feet by sixteen feet may be created should eight (8) four foot (4′) by ten foot (10′) individual mats be joined on long sides and short sides. Elongated mats may also be employed in embodiments. For example, 12″-18″ (wide)×12′-18′ (long) or more or less mat may be employed. These elongated designs may employ passages but may also not when their spacing apart from each other is large enough to provide adequate gas flow to lower infiltration fields or other water treatment system components. A specific example of elongated may comprise a pair of mats 12″-24″ wide spaced three feet apart from each other and having a length of six feet or more. Another example of a mat system providing adequate air flow without passages is shown in FIG. 13. Numerous other sizes, configurations, and placements of individual mats, mat pairs, mat groupings, and ventilated mat systems may also be employed in embodiments. These various sizes may be selected to cover most or all of an infiltration field or other water treatment system component. The various sizes of the ventilated mat system may be selected to be larger than one or two, or three or all sides of an underlying infiltration field or other water treatment system component.

Joining individual mats may employ various techniques and designs. Lap joints, male/female joints, pivoting joints, rigid joints, flexible joints, stiff joints, joints with pins or other added tightening components, may each be employed in embodiments. The joinery may or may not be configured to transfer lateral loading, shear loading, or torsional loading, within or between ventilated mats of embodiments. Exemplary joints are shown in FIG. 11.

Ventilated mat systems may comprise a single or multiple ventilated mats. The ventilated mat system may be assembled in-situ, i.e., created and installed at an installation site. For example, concrete ventilated mats may be formed and placed on-site. Ventilated mats of embodiments may be assembled prior to placement, and may reside elsewhere prior to installation, e.g., be fully or partially assembled for transport, during manufacture, for on-site assembly, etc. The mat(s) may be transportable or may also be assembled at a water treatment system site ahead of final placement and installation.

In some embodiments, water distribution of an infiltration field may be via a distribution layer such as a distribution conduit positioned in direct contact with a dosing conduit of an infiltration field. The water egress portion of the infiltration field, e.g., a dosing conduit, may be positioned at the bottom and/or—along the sides of an infiltration field galley, at the bottom and/or along the sides of a channel, at the bottom or along the sides of an infiltration baffle matrix, and/or at the bottom or along the sides of water egress areas of a channel or other areas of an infiltration field. Ventilated mat systems may be employed above these or other components of a water treatment system. And in so doing, may provide for live loading support or live loading reduction of vehicular traffic passing above these components onto underlying water treatment system components. Ventilated matting and associated footings, in certain cases themselves with ventilated sidewalls, may serve as the water infiltration and treatment device.

A distribution conduit as used herein should be understood to mean a fluid passage that may comprise: a pipe that permits the passage of water or a fluid conductive structure that permits the passage of water, or a fluid conductive material that permits the passage of water, as well as combinations thereof. Water should be able to be passed from one channel to another channel by one or more distribution conduit. Fluid conductive material may contain fabric or filaments or plastic or stone as well as combinations thereof. Distribution conduits may have various thicknesses where a typical thickness range can comprise at least about one-eighth inch to about two inches or more of thickness. A distribution conduit permits the passage of water within it and can be hollow as well as not hollow, but ventilated or otherwise forming a via to water to allow the passage of water by the distribution conduit. The flow rates of water via the distribution conduit are typically similar or greater than the flow rates of water within the channels. In other words, water may flow as freely or more freely via the distribution conduit as flow in the channels. The distribution conduit may be hollow such as flat pipe conduit. The distribution conduit can comprise material such as geotextile mat, woven material, three-dimensional plastic grid, crenulated material, layered material, and cuspated material. The distribution conduit can underlie an infiltration module whether the module is yet to be installed or is installed in the ground. The distribution conduit can also be positioned along one or more sides of an infiltration module whether the module is yet to be installed or is installed in the ground. The distribution conduit is preferably in direct fluid contact with an infiltration field once fully installed and backfilled such that water may flow via the distribution conduit.

As noted above, ventilated mat systems of embodiments may be assembled on site or may be manufactured off site or combinations of both. Transportable ventilated mat systems may be assembled off-site and then placed at an infiltration field and partially or finally assembled on site. Infiltration fields may also be partially or fully assembled on site, connected, and backfilled in embodiments. A distribution conduit may be employed in some or all infiltration field areas of embodiments, whereby the distribution conduit may be in direct contact with some or all channels, infiltration baffle matrix, or other water conveying portions of the infiltration module or in-situ infiltration field, so as to be configured to provide water distribution, e.g., water transport and/or water balancing between and/or within the water conveying portions of the infiltration module or in-situ infiltration field.

Accordingly, embodiments may comprise a ventilated mat system with a plurality of separate ventilated mats positioned over a distribution conduit, dosing pipe, an infiltration field, or other water treatment system component. The ventilated mats can be touching each other and/or spaced apart from each other with gaps for air, filter fabric, sand etc. The ventilated mats can be planar or substantially planar and positioned in direct contact infiltration infield components or other water treatment system components. The ventilated mats may comprise a ventilated core in certain embodiments. The ventilated mats may be egg-crate like, plastic, concrete, metal, etc. with passages having or lacking specific repeating patterns.

Geotextile fabric employed in infiltration fields or with ventilated mat systems may have a regular thickness of 0.001-0.1″ or so, as well as be thinner or thicker. A distribution conduit of a water treatment system can have a regular thickness of 1″-2″ or so, as well as be thinner or thicker. Exemplary distribution conduits may be made from entangled polymer filaments or threads, polymers, stone, three-dimensional structures, flat pipes, and other materials as explained herein. The distribution conduits, which may have a uniform or varying thickness, may be sized and shaped to redistribute wastewater from one area of an infiltration field to other areas of an infiltration field. In these and other examples, ventilated mat systems may be assembled and positioned above to protect the distribution conduit or other component of a water treatment system from vehicular traffic loading. This protection may comprise spreading received live loads from a top surface of the ventilated mat by a vehicle to acceptable loading below the ventilated mat. For example, live loads of 80 PSI may be reduced in embodiments by the configuration of the ventilated mats system to less than 11 PSI by underlying soil positioned above underlying water treatment system components. The reduction in live load may be accomplished by various design features of the mat system including the use of footings, the thickness of the ventilated mat, the rigidity of the ventilated mat, reinforcement within the mat, the size of the ventilated mat or by other design features as well.

Surface water can travel through passages of a ventilated mat system and pass downwardly through an infiltration field positioned below the ventilated mat system. In some embodiments, exposed surfaces of ventilated mat systems may be pitched so as to guide or manage water surface flow. This pitching may guide stormwater flow or other surface water flow away from passages in the ventilated mat surface and, thereby, reduce water loading on lower infiltration fields or other water treatment components.

Ventilated mats of embodiments may be manufactured partially or fully offsite and transported to a jobsite, for final assembly if needed, for connection to one or more other mats, and for final installation with a water treatment system. Partially assembled ventilated mat systems may contain forms and reinforcing steel sized and shaped to form ventilated mat systems taught herein. For example, exemplary forms may contain numerous columns spaced apart from each other, the columns sized to create the passages in placed concrete as taught herein. The columns may be laid out in a grid or may be moveable such that the passage location can be more selectively chosen at an installation site or by an earlier predetermined design. The partially assembled ventilated mats may also comprise one or more dosing conduit coupled to the mats. The distribution conduit may also be included in a partially assembled ventilated mat system, whereby the mat may be positioned and secured with the distribution conduit or dosing conduit. Partially assembled ventilated mats may be transported to a job site for layout, final assembly and connection. The final assembly and connection may include attaching dosing conduits to ventilated mats and to each other, attaching the distribution conduit to one or more infiltration field components, wrapping or placing filter fabric at or around various components and sides, placing or forming footings to support the ventilated mats, linking some but not all ventilated mats of a ventilated mat system, and backfilling an infiltration field or other water treatment system component before placement of a ventilated mat system above the component.

Embodiments may also comprise placing or otherwise retrofitting existing infiltration fields or other water treatment system components with ventilated mat systems. These ventilated mats may be placed over functioning infiltration fields or other components and may, thereby, provide for vehicular traffic or parking which may have been previously impermissible due to unwanted loading reaching the existing water treatment system components.

Embodiments may be employed with components of a single water treatment system as well as with components of multiple water treatment systems. For example, infiltration fields of adjacent water treatment systems may be covered by a single ventilated mat system.

Ventilated mat systems of some embodiments may be removable to allow for inspection, service, and other procedures necessitating access to underlying water treatment system components. For example, active blowers or passive vents located underneath a ventilated mat may be accessed in some embodiments by decoupling the ventilated mat from attached neighboring ventilated mats and lifting the ventilated mat to allow access to the underlying blower, vent, or other component.

An infiltration field of embodiments may comprise an infiltration module with a plurality of channels arranged as a baffle matrix having a plurality of upright walls, where some of the walls may be spaced apart from others. Wastewater may be fed into these spacings between walls and travel downwards through the channels arranged as a baffle matrix until the water reaches a distribution conduit sitting below and/or to the side of the channels arranged as a baffle matrix. The wastewater may be fed from a dosing conduit or other wastewater transport. The channels arranged as a baffle matrix may sit atop a filter fabric and/or be individually or cumulatively wrapped in filter fabric. A ventilated core distribution conduit may sit below the channels arranged as a baffle matrix and may be touching the filter fabric or the channels arranged as a baffle matrix directly. The distribution conduit, which may have a uniform or varying thickness, may be sized and shaped to redistribute wastewater from one area of the channels arranged as a baffle matrix to another area of the channels arranged as a baffle matrix. The distribution conduit serves to redistribute water that may predominantly flow through one or more channels arranged as a baffle matrix. The water can travel through the underlying and or/surrounding ventilated distribution conduit and enter other channels of the baffle matrix from the bottom and/or sides. This ultimately serves to prevent fluid overloading associated with certain channels of the baffle matrix and redistributes the flow to all the channels of the baffle matrix even if it is initially directed to a fraction of channels. This ultimately allows systems to treat more completely and enhance the lifespan of the system. Channels arranged as a baffle matrix may be considered to be a type of infiltration field component. The channels arranged as a baffle matrix may be transportable and configured as an infiltration module and may also be assembled on-site to form its constituent parts. The channels arranged as a baffle matrix in preferred embodiments can have a plurality of upright walls that are spaced apart from each other where water is intended to be fed into spaces between the walls. The walls may have different heights and/or positions such that some of the walls reach and touch a distribution conduit, whether distribution conduit is on the sides or bottoms of the channels, while other walls do not necessarily reach and touch the distribution conduit. Water may be redistributed within channels arranged as a baffle matrix by flowing below walls that touch the distribution conduit.

Embodiments may comprise a water infiltration system, prior to installation, comprising a plurality of upright channels, each channel having an upright passage with an open or ventilated bottom or side, each channel having a height and a width; and a distribution conduit having a thickness of 0.0125 inches or more positioned on a side and/or partially underneath the plurality of upright channels, the distribution conduit touching a portion of the bottom and/or a portion of the side of an infiltration channel of the plurality of upright channels. In some embodiments, a water infiltration field system, which may include upright passages of channels of a plurality of upright channels, may be parallel to each other. In some embodiments a distribution conduit may comprise an outer surface of geotextile fabric that would contact surrounding treatment medium. In some embodiments a treatment medium may be beneath and/or beside the distribution conduit. In some embodiments, when installed, a bottom of each channel of a plurality of upright channels may be more water ventilated than surrounding treatment medium. In some embodiments, when installed, a distribution conduit may be more ventilated than surrounding sand or soil. In some embodiments, each channel of a plurality of upright channels may comprise an upright cuspated wall. In some embodiments the height to width aspect ratio of each channel is three or more and no more than 96.

Embodiments may comprise a water infiltration field system underlying a ventilated mat system, the field comprising a first upright channel; a second upright channel adjacent to the first upright channel; a conduit in fluid communication with the first and second upright channels; and a distribution conduit having a thickness of 0.0125 inches or more and positioned underneath and/or covering a portion of one or more sides and touching the first and second upright channels. In some embodiments, a distribution conduit has a thickness of ¾ inch or more and a first upright channel and a second upright channel each have a height to width aspect ratio of three or more and no more than 96. In some embodiments, a distribution conduit comprises a repeating plastic grid. In some embodiments, a distribution conduit comprises a stringy structure comprising entangled polymer filaments. In some embodiments, a first upright channel is parallel to a second upright channel. In some embodiments, a first upright channel is wrapped with geotextile fabric and a distribution conduit is wrapped with geotextile fabric and the height to width aspect ratio of the first upright channel is different than the height to width aspect ratio of a second upright channel. In some embodiments, a distribution conduit is at least partially underlain by a treatment medium. In some embodiments, a first upright channel and a second upright channel have a treatment medium at least partially below them. In some embodiments, a treatment medium comprises sand or soil.

Embodiments may comprise a transportable water infiltration field system underlying a ventilated mat system, the field comprising a plurality of upright channels, each channel having a plurality of upright walls some of which may be covered in filter fabric, each channel having a height and a width; and a distribution conduit having a thickness of 0.0125 inches or more positioned underneath each channel of the plurality of upright channels, the distribution conduit touching a bottom and/or side of each channel of the plurality of upright channels or the distribution conduit touching the bottom portion of an upright interface or filter fabric of each channel of the plurality of channels. In some embodiments, at least one upright channel of a plurality of upright channels comprises sand. In some embodiments, filter fabric may be positioned along at least some upright walls of the plurality of upright walls. In some embodiments, a first upright channel of a plurality of upright channels has a first height to width aspect ratio and a second upright channel of a plurality of upright channels has a second height to width aspect ratio, the second height to width aspect ratio being larger than the first height to width aspect ratio. In some embodiments, the height to width aspect ratio of each upright channel of a plurality of upright channels is three or more and no more than 96. In some embodiments, when installed, a treatment medium may be positioned outside of at least one upright channel of a plurality of upright channels and below a distribution conduit.

Embodiments may comprise a transportable water infiltration field system underlying a ventilated mat system, the field comprising an infiltration baffle matrix, the infiltration baffle matrix having a height, a width, and a length, the infiltration baffle matrix comprising a plurality of upright walls, where at least some of the upright walls are distinct and separated from each other; and a distribution conduit having a thickness of 0.0125 inches or more positioned underneath a majority of the width and length of a majority of the infiltration baffles. In some embodiments, filter fabric can be positioned about an infiltration field and a distribution conduit. In some embodiments, when connected to a wastewater source, a dosing conduit may be in fluid communication with the infiltration baffle matrix, the dosing conduit may be positioned to discharge wastewater atop or into at least some of the upright walls of the infiltration baffle. In some embodiments, one or more upright walls comprises a polymer and/or a filter fabric, wherein a majority of upright walls of an infiltration baffle matrix may be parallel to each other, and the infiltration baffle matrix may at least be partially wrapped in filter fabric. In some embodiments, a first upright wall of a plurality of walls may be solid and comprise a first polymer and a second upright wall of a plurality of walls comprises the first polymer and comprises perforations. In some embodiments, a plurality of upright walls comprises at least six upright walls.

Embodiments may comprise methods of assembling a leaching field. These or other processes may comprise placing a dosing pipe into fluid communication with an infiltration field having a perimeter, the infiltration field comprising a treatment media, the infiltration field passing effluent water received from the dosing pipe downward and into soil beneath the infiltration field and within the perimeter of the infiltration field and placing a structural form atop the infiltration field, the structural form comprising a plurality of passages. The structural form may be configured to mold concrete or other material during its curing period.

In embodiments water may pass downwardly through the bottom and/or sides of the infiltration field. In embodiments ventilated mats may be configured as a floating slab and or comprising a perimeter foundation. In embodiments, passages spacing may be small enough to prevent tire penetration, e.g., 4″ or 6″ and/or sized to support a tire contact patch. Passage spacing of ventilated mat systems may be sufficient to prevent tire compaction of soil or other material present within the passages and/or below the ventilated mat system. Stone or grass or soil may each be present in the passages. In some embodiments, a percentage of overall mat area may comprise cumulative passage area of 50% or more of the overall mat area. In some embodiments, passage area to mat area may be determined via gas flow measurements, whereby enough passage surface area and passage volume may be present to support sufficient gas flow to and from an infiltration field or other underlying water treatment system component.

In embodiments, ventilated mats may have various cross-sectional profile shapes. These shapes may comprise I-beam cross-section; c-section; L-section; Y-section; flat bottom rounded top; and other cross-sectional profiles as well. Passages may comprise stone, soil, treatment media, or other materials. Ventilated mats may comprise various materials, such as concrete, plastic, metal, carbon reinforced fiber; and wood. Ventilated mat systems may comprise perimeter footings and or central footings. Upper surfaces of a ventilated mat system may be level with existing surfaces and/or may be slightly proud of existing surfaces. Access points for inspection may be present in ventilated mat systems. Upper surfaces of ventilated mats may be configured to accommodate surface sheet flow of water as well as integration of nitrogen, phosphorus or other compounds. Ventilated mat systems may have various thicknesses. Four inches or more may be preferred and may depend on the material of the ventilated mat and the span to be accommodated. Department of Transportation regulations may be considered when developing the thickness, spans, shape, and other configurations of ventilated mats. The ventilated mats may be lifted into place or removed via accessible rings or other connection points. Ventilated mats can be various sizes—4′×12′ or 8′×8′ or other sizes. In embodiments, the ventilated mats may be sized for transport via truck or other over the road vehicle. Foundations in embodiments may extend to the bottom of an infiltration field whereby footings should be well drained below to avoid frost heave. Features of a ventilated mat system may be selected such that soil compaction is minimized below the ventilated mat system when considering live loading of motor vehicles. The imposed live loads may be reduced via the above or other design criteria such that imposed live loads from vehicular traffic mimics that of foot traffic or lawn service mowers and the like. In other words, the ventilated mat system may be configured such that when a motor vehicle is parked on or drives over, the soil above an underlying water treatment system component does not experience related live loading greater than what would be imposed by a commercial lawn mower or simple foot traffic if the ventilated mat system was not present.

Embodiments may comprise a process of assembling a water infiltration field system comprising: providing a ventilated mat, the ventilated mat comprising a plurality of passages, each of the passages of the plurality of passages extending from an opening in a top surface of the ventilated mat to a lower surface of the ventilated mat, the top surface having a measurable surface area, the measurable surface area calculated by a length of the top surface multiplied by a width of the top surface, the width of the top surface being at least 18 inches and the length at least 4 feet, the openings of the plurality of passages in the top surface occupying at least 25% of the measurable surface area of the top surface of the ventilated mat, the ventilated mat comprising a polymer and/or a portland cement; and positioning the ventilated mat over at least a portion of a water infiltration field system, wherein at least a portion of the top surface of the ventilated mat remains exposed when the ventilated mat is positioned over the water infiltration field system, and wherein the portion of the top surface that remains exposed is positioned to permit air flow from above the positioned ventilated mat and to the water infiltration field system.

In some embodiments, a ventilated mat may be configured to transfer a live load applied over a first area of the top surface to a second larger area on the lower surface of the ventilated mat. In certain embodiments, a transferred live load when measured may not exceed four hundred thirty-two pounds per foot.

Embodiments may comprise a water infiltration field system assembly process, providing a ventilated mat comprising a first surface and a second surface, the second surface opposite the first surface, the first surface having a width of at least 18 inches and a length of at least four feet, the ventilated mat comprising pre-cast concrete, the ventilated mat comprising a plurality of air passages, each air passage of the plurality of air passages extending from an opening in the first surface of the ventilated mat to an opening in the second surface of the ventilated mat, the ventilated mat having a thickness and internal reinforcement, the second surface having a substantially planar configuration, the ventilated mat having a widthwise cross-sectional profile, the widthwise cross-sectional profile configured to support an active load acting on the first surface of the ventilated mat; and placing the ventilated mat above an infiltration field, the first surface of the ventilated mat at least partially exposed after placement, the exposed first surface positioned to come in contact with a surface motor vehicle.

Embodiments may comprise a process of assembling a water infiltration field system, the process comprising: providing a ventilated mat, the ventilated mat having a thickness, the ventilated mat having a first surface with a length and a width, the ventilated mat comprising reinforced concrete, a polymer, metal, or wood, the ventilated mat having a plurality of passages through the thickness, each passage sized to permit air flow from the first surface of the ventilated mat to a second surface of the ventilated mat, the first surface opposite the second surface, each passage of the plurality of passages having an exposed opening at the first surface, the cumulative area of all of the exposed openings being greater than 25% of the length times the width of the first surface; and positioning the ventilated mat over at least a portion of a water infiltration field system, wherein at least a portion of the ventilated mat remains exposed and in position for contact with a motor vehicle above the positioned ventilated mat, the passages located to permit air flow from above the positioned ventilated mat to the water infiltration field system.

Embodiments may comprise processes of assembling a water infiltration field system. These may comprise providing a ventilated mat, the ventilated mat may comprise a plurality of passages, each of the passages of the plurality of passages may extend from an opening in a top surface of the ventilated mat to a lower surface of the ventilated mat, the top surface may have a measurable surface area, the measurable surface area may be calculated by a length of the top surface multiplied by a width of the top surface, the width of the top surface may be at least one foot. In some embodiments, the openings of the plurality of passages in the top surface may occupy at least half of the measurable surface area of the top surface of the ventilated mat. Process embodiments may also comprise positioning the ventilated mat over at least a portion of a water infiltration field system, wherein, in some embodiments, at least a portion of the top surface of the ventilated mat may remain exposed when the ventilated mat is positioned over the water infiltration field system and the water infiltration system is operational. In some embodiments, the portion of the top surface that remains exposed may also be in position for contact with a motor vehicle located above the positioned ventilated mat, the passages positioned to permit at least air, gas, or vapor flow between the atmosphere and the water infiltration field system, and the ventilated mat may be configured to reduce imposed motor vehicle live wheel loads of up to 8,000 lbs. placed atop the ventilated mat from a single stationary motor vehicle to no more than 12.0 PSI when measured below the ventilated mat.

In some embodiments, the ventilated mat may comprise concrete and the passages may have upper and lower openings that are different sizes. In some embodiments, the ventilated mat may be configured to reduce imposed motor vehicle live wheel loads of up to 8,000 lbs. placed atop the ventilated mat from a single stationary motor vehicle to no more than 5.0 PSI when measured below the ventilated mat. In some embodiments, the ventilated mat may be configured to reduce imposed motor vehicle live wheel loads of up to 8,000 lbs. placed atop the ventilated mat from a single stationary motor vehicle to no more than 2.0 PSI when measured below the ventilated mat. In some embodiments, the ventilated mat may comprise a polymer and the passages may be cylindrical in shape.

Process embodiments may comprise a water infiltration field system assembly process comprising providing a ventilated mat comprising a first surface and a second surface, the second surface opposite the first surface, the first surface having a width of at least two feet and a length of at least four feet; and placing the ventilated mat above an infiltration field, the first surface of the ventilated mat at least partially exposed after placement, the exposed first surface positioned to come in contact with a tire of a motor vehicle. In some embodiments, the ventilated mat may comprise a plurality of air passages, each air passage of the plurality of air passages extending from an opening in the first surface of the ventilated mat to an opening in the second surface of the ventilated mat. In some embodiments, the ventilated mat may be configured to withstand an axle loading of 16,000 pounds acting on the first surface and to transfer that load such that the second surface imposes a pressure of no more than 8.0 PSI to the infiltration field.

Some embodiments may comprise providing a ventilated mat, comprises providing a concrete form, the concrete form comprising a plurality of inner walls shaped to a plurality of passages, the concrete form further comprising an outer wall surrounding the plurality of inner walls. In some embodiments, at least some of the plurality of passages may be cylindrical in shape or have a conical shape or are elongated or are nonuniform in length. In some embodiments, the outer wall of the form may be a polygon.

Some process embodiments may comprise a process of constructing a water infiltration system. These may comprise placing a ventilated mat over a wastewater infiltration field, the wastewater infiltration field having a width and a length, and a surface area measured as width times length, the surface area being a minimum of sixteen square feet, wherein the ventilated mat may be positioned to receive motor vehicular axle loads up to 32,000 lbs. In some embodiments, the ventilated mat may be sized to span at least the width or at least the length of the wastewater infiltration field, the ventilated mat may be sized and shaped to transfer and reduce a downwardly imposed motor vehicle wheel load from above the ventilated mat to a reduced wheel load below the ventilated mat. In some embodiments, a ventilated mat may have a plurality of passages positioned to transfer air, gases, or vapor, including water vapor, through the ventilated mat and each passage of the plurality of passages may have an upper exposed opening, the cumulative area of all the upper openings of the passages from the plurality of passages may be at least 25% of the surface area of the ventilated mat.

In some embodiments, placing a free draining traffic rated aggregate over the ventilated mat may be performed. In some embodiments aggregate, soil (including sand, etc.) may be present in the passages as well as above the ventilated mat. In some embodiments, the aggregate may range from ¼ inch to 3 inch (sieve) size and the cumulative area of all the upper openings of the passages from the plurality of passages may be more than 40% of the surface area of the ventilated mat. In some embodiments, the ventilated mat may be sized and shaped to transfer and reduce a downwardly imposed motor vehicle wheel load of no more than 8,000 lbs. from above the ventilated mat, to a reduced transferred pressure imposed below the ventilated mat of no more than 12.0 PSI below planar portions of the ventilated mat.

In some embodiments the ventilated mat may be sized and shaped to transfer and reduce a downwardly imposed motor vehicle wheel load of no more than 8,000 lbs., from above the ventilated mat, to a reduced transferred pressure imposed below the ventilated mat of no more than 5.0 PSI below planar portions of the ventilated mat. In some embodiments, the ventilated mat may be sized and shaped to transfer and reduce a downwardly imposed motor vehicle wheel load of no more than 8,000 lbs., from above the ventilated mat, to a reduced transferred pressure imposed below the ventilated mat of no more than 2.0 PSI below planar portions of the ventilated mat. In some embodiments, the ventilated mat may be sized and shaped to transfer and reduce a downwardly imposed motor vehicle wheel load from above the ventilated mat to a reduced wheel load below without shear failure of the ventilated mat.

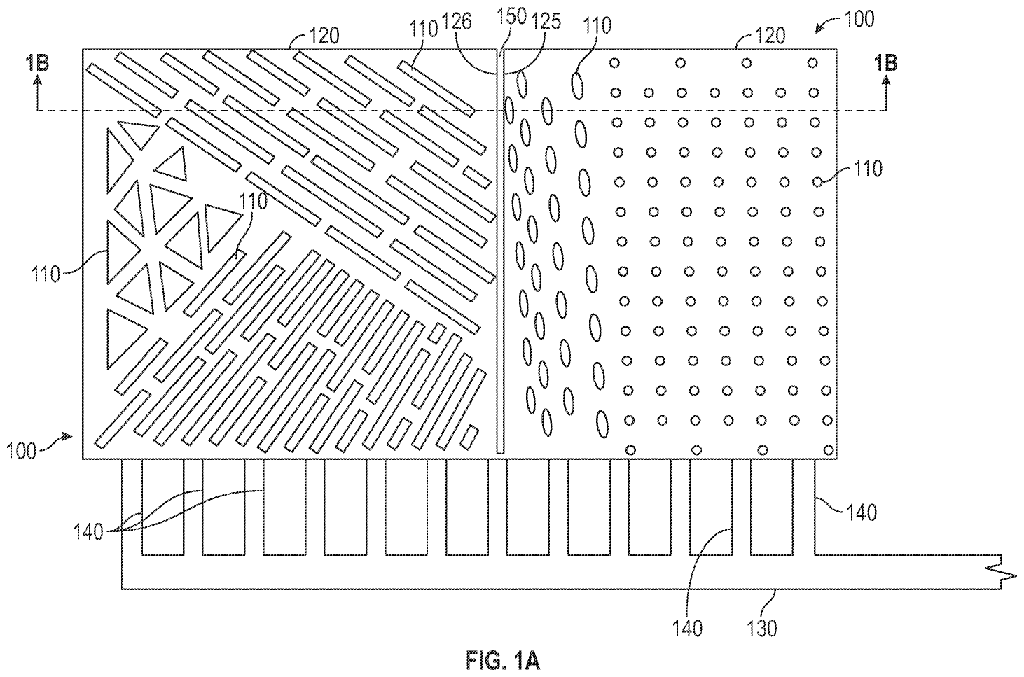

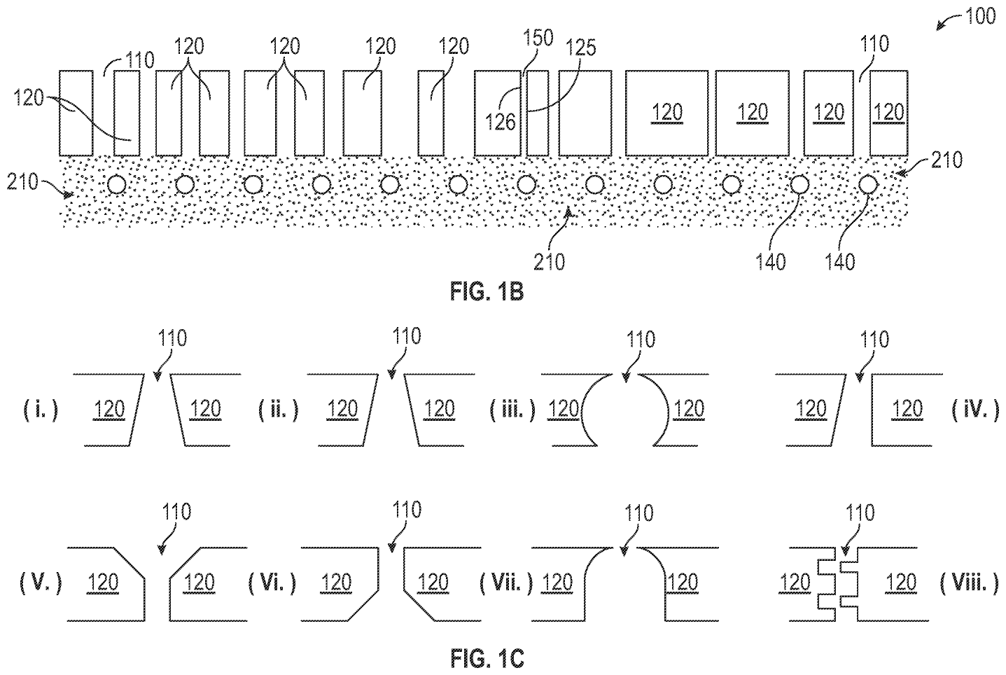

FIG. 1A provides a top view schematic of a ventilated mat system 100, the ventilated mat system 100 with a plurality of passages 110 therethrough, the ventilated mat system positioned atop of dosing conduits 140 of a subsurface infiltration field of a water treatment system, as may be employed in some embodiments. The dosing conduits 140 are shown manifolded together and being fed from a distribution conduit 130. The ventilated mat system 100 is shown with two ventilated mats 120 joined to each other along adjacent sides 125 and 126 and via joint 150. In embodiments, as is shown in FIG. 1A, the passages 110 may have various shapes, sizes, spacings, locations, and orientations. These passages may be located, shaped, and sized such that gas may pass through the ventilated mats 120 to underlying dosing conduits 140 and treatment media in which the dosing conduits may be situated in. The joint along adjacent sides 125 and 126 may be made with various joinery techniques, including those shown in FIG. 11 below. The ventilated mats 120 may comprise various materials, such as concrete, reinforced concrete, polymers, wood, steel, aluminum, iron, other metals, composite materials, carbon reinforced materials, carbon reinforced laminates, among other materials. The passages may be cumulatively sized to represent a meaningful portion of the surface area of the ventilated mat system 100. For example, the surface area of the two ventilated mats 120 may have passages that cumulatively represent 25%, 30%, 35%, 40%, 45% 50%, 55%, 60%, 65%, 70%, 75% or more. The percentage of passageway surface area versus total ventilated mat surface area may be selected to coincide with neighboring materials. For example, if the porosity of adjacent soils is 17%, thereby allowing gas to flow therethrough via this porosity, the total passages surface area may be selected to be at least 17% for that particular location. Higher cumulative passage areas to total ventilated mat surface area may also be selected in embodiments, so as to provide more gas to underlying infiltration fields or other water treatment system components. If ratios of cumulative passage area to total ventilated mat surface area are lower than the porosity of surrounding soils or other materials, additional techniques for inducing gas flow through the ventilated mat may be employed so as to provide a minimum gas flow consistent with that of surrounding materials.

FIG. 1B provides a sectional side view along line 1B-1B of the ventilated mat system 100 of FIG. 1A as may be employed in some embodiments. The passages 110 are shown to be cylindrical in cross section, although other cross-sections are possible. FIG. 1C shows exemplary passage cross-sections as well. The surface area of the passage 110 may be measured at its narrowest point in the passage. This may be anywhere along the length of a cylindrical passage. An inverted truncated cone may be measured at its top as this is the narrowest point of the passage. Other passage configurations may also be used, e.g., frustrum, wedge, obelisk, pyramid, cube, prism, the examples of FIG. 1C, and all these, too, may be measured at their narrowest point when considering cumulative surface area of the passages versus surface area of a ventilated mat. The joint 150 between adjacent ventilated mats may have various configurations and may be self-locking or require additional components. Combinations may also be employed. FIG. 11 shows various configurations that may be employed. Other joint configurations are also plausible in embodiments. The dosing conduits 140 are shown along the bottom of the ventilated mats 120 and shown to be spaced apart from the lower surface of the ventilated mats 120. During installation, the dosing conduits 140, which may have various configurations, including circular pipes, flat pipe, open channels, etc. may be placed, covered with treatment media or other fill 210, and then entombed by placement of the ventilated mat system 100 above. The ventilated mat system 100 may be a slab on grade type configuration where an under surface lies atop of and is supported by the treatment media. The ventilated mat system may also employ footings that carry a load and are positioned so as not to interfere with any dosing conduits 140 or other component of a water treatment system.

FIG. 1C provides a sectional side view of exemplary passage 110 configurations as may be employed in ventilated mat systems 100 and ventilated mats 120 of some embodiments. Passage (i.) is shown as a truncated cone; passage (ii.) is shown as an inverted truncated cone; passage (iii.) is shown as a spherical shape; passage (iv.) is shown with one vertical side and one slanted side; passage (v.) is shown as a funnel; passage (vi.) is shown as an inverted funnel; passage (vii.) is shown as a dome; and passage (viii.) is shown with interspaced teeth. These passage shapes may be mixed in a single ventilated mat and may be employed with other configurations as well. Ventilated mats may use still other passage configurations.

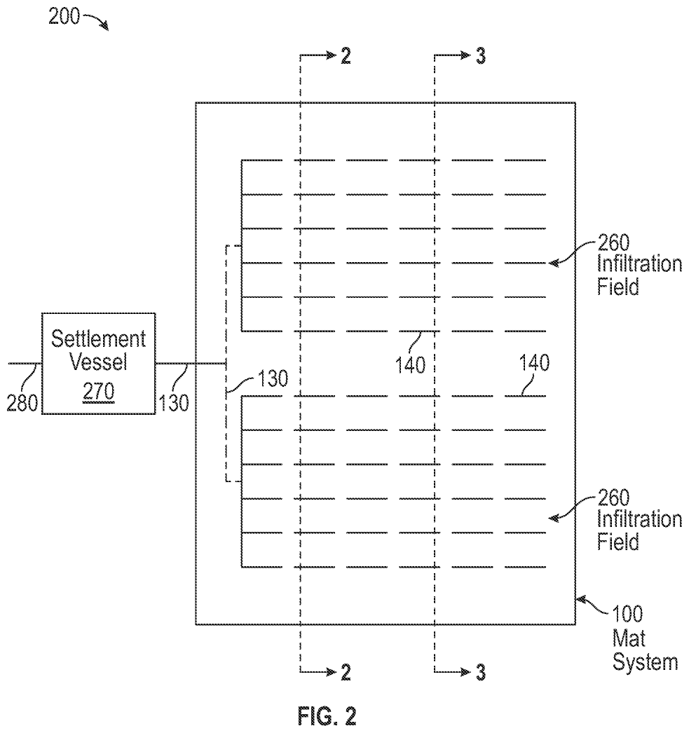

FIG. 2 provides a top view schematic of a ventilated mat system 100, the ventilated mat system with a plurality of passages therethrough, the ventilated mat system positioned atop of dosing conduits 140 of subsurface infiltration fields 260 of a water treatment system 200 as may be employed in some embodiments. The mat system comprises multiple ventilated mats and sits atop two infiltration fields 260. The infiltration fields 260 are fed via distribution conduits 130. The distribution conduits are fed from settlement vessel 270, which is in turn fed from source 280. The source 280 may be various sources including a residential or commercial source of water. The top down view of FIG. 2 shows that the perimeter of the mat system 100 completely covers the two underlying infiltration fields 260. In embodiments, however, a mat system may not completely cover an infiltration field or other component of a water treatment system. In some embodiments the location and area size may be selected considering the location of anticipated vehicular loading and the placement of the water treatment system relative to that vehicular loading. The outer perimeters of the multiple ventilated mats comprising the mat system 100 are not shown for clarity purposes. However, the mat system 100 may also be a single ventilated mat in some embodiments as well.

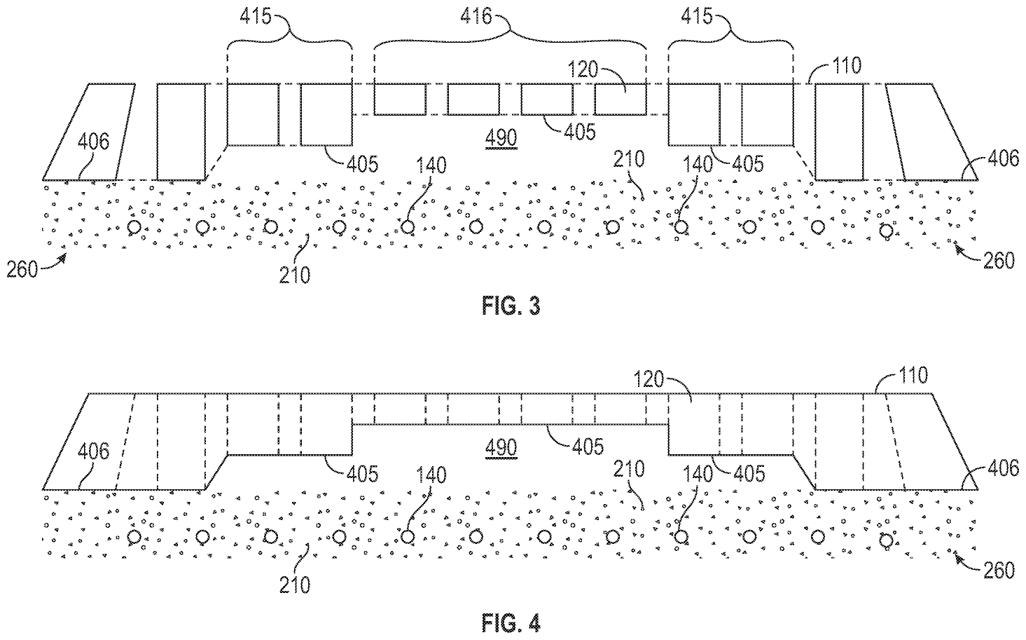

FIG. 3 provides a sectional side view along line 3-3 of the ventilated mat system 100 of FIG. 2, with underlying dosing conduits 140, as may be employed in some embodiments. The treatment media 210 is shown. As can be seen, there are areas 490 below the bottom surface 405 of the ventilated mat(s) 120 without treatment media 210. These areas without underlying treatment media are supported by other areas of the ventilated mat(s) 210. These ventilated mats may contain reinforcement to provide the rigidity and other structural properties needed to support top side vehicular loading. The bottom surfaces 406 of the ventilated mat(s) 120 are shown in contact with the treatment media 210 of the infiltration field 260. These bottom surfaces are serving as footings for the ventilated mat system 100 as the footings are sized and positioned to carry vehicular load on the ventilated mat system 100 from above to the underlying supporting infiltration field 260. In some embodiments no dosing conduits may be located below footings of a ventilated mat system, while in some embodiments footings may be located above dosing conduits or portions thereof. The passages 110 are also visible in FIG. 3, which shows that cross-sections of the passages may differ and may also be the same in ventilated mat systems. This cross-sectional view of FIG. 3 also shows that the cross-section thickness of ventilated mats of embodiments may change over their span or length or width. Thinner middle sections 415 and 416, which are anticipated to carry lower moment loading under live vehicular loading or static loading, may be employed to lower ventilated mat weight, to reduce needed material for the ventilated mat, and for other reasons as well.

FIG. 4 provides a sectional side view along line 4-4 of the ventilated mat system 100 of FIG. 2, with underlying dosing conduits 140, as may be employed in some embodiments. As with FIG. 3, treatment media 210 is shown and there are areas 490 below the bottom surface 405 of the ventilated mat(s) 120 without treatment media 210. These areas without underlying treatment media are supported by other areas of the ventilated mat(s) 210. As also shown in FIG. 3, bottom surfaces 406 of the ventilated mat(s) 120 are in contact with the treatment media 210 of the infiltration field 260 and these bottom surfaces serve as footings for the ventilated mat system 100 with the footings being sized and positioned to carry vehicular load on the ventilated mat system 100 from above to the underlying supporting infiltration field 260. The passages 110 are also visible in FIG. 4, which, like FIG. 3, shows that cross-sections of the passages may differ and may also be the same in ventilated mat systems. This cross-sectional view of FIG. 4 also shows that the cross-section thickness of ventilated mats of embodiments may change over their span or length or width. Thinner middle sections 415 and 416, which are anticipated to carry lower moment loading under live vehicular loading or static loading, may be employed to lower ventilated mat weight, to reduce needed material for the ventilated mat, and for other reasons as well. Here, as with other embodiments, applied loads to the soil or material directly above the water treatment system components may be designated to not exceed a maximum value similar to that imposed by walking, riding mowers, pedestrian traffic, or other lower load values suitable to minimize or eliminate soil compaction and, thereby maintain air flow through the soil and to and from the underlying water treatment system components. When footings are used and located outside of the water treatment system components, the imposed soil loads directly below the footings may be higher as soil compaction in areas directly below the footings and not above the water treatment system may not be needed for proper air flow to and from the infiltration field or other water treatment system component.

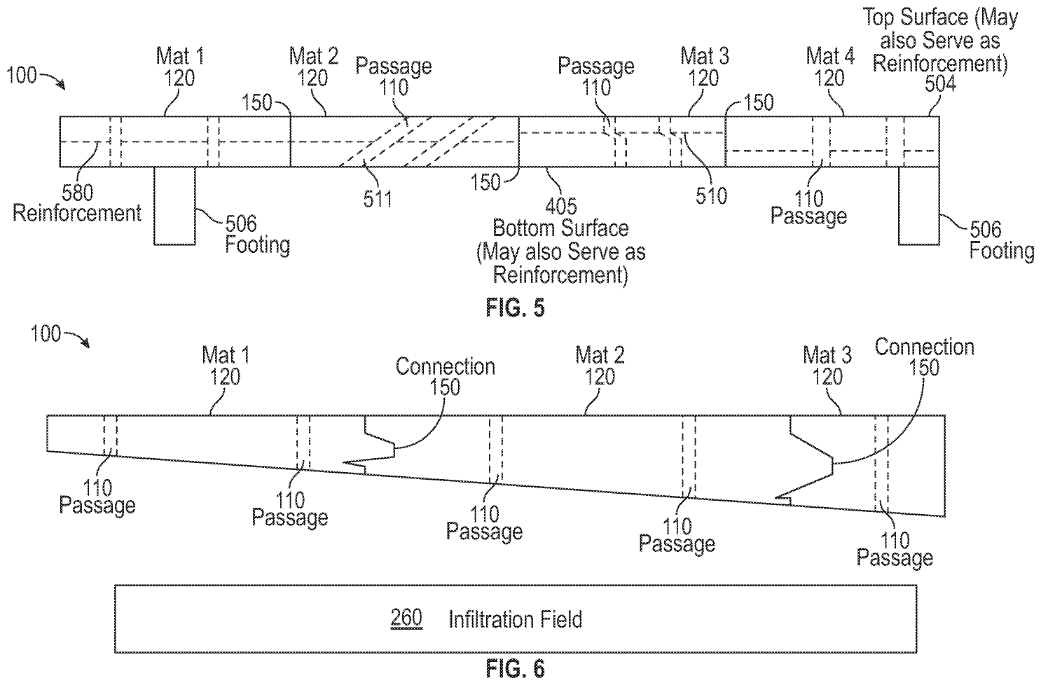

FIG. 5 provides a side view of a ventilated mat system 100, with underlying footings 506, as may be employed in some embodiments. The ventilated mat system 100 is shown with four ventilated mats 120, each having passages 110. These passages 110 are shown with various profiles, some being straight while others being angled 511 or having turns 510 within them. The footings 506 are shown at a perimeter of a ventilated mat and not at a perimeter of a ventilated mat. Footing location may be selected in embodiments to accommodate infiltration field location and anticipated live vehicular loading. Reinforcement 580 is also shown. This reinforcement 580 may be positioned across the length and width of ventilated mat systems. In so doing, rigidity and strength may be designed and controlled for anticipated live and dead loading scenarios. Joints 150 between adjacent ventilated mats are also shown in FIG. 5. These joints may have various configurations and are shown in FIG. 5 as being fairly upright in their orientation. The top surface and bottom surface of the ventilated mat system are shown being substantially parallel to each other, e.g., like a steel plate. However, in some embodiments, the top and bottom surfaces of the ventilated mats may not be parallel or not substantially parallel.

FIG. 6 provides a side view of a ventilated mat system 100, with underlying infiltration field 260, as may be employed in some embodiments. Three ventilated mats 120 with joints 150 are shown in FIG. 6. The joints 150 are shown with an alignment and securement configuration. This configuration may assist in alignment between ventilated mats during assembly and with securing these ventilated mats together once aligned and located next to each other. The top surfaces of the ventilated mats 120 are not shown to be parallel to the bottom surfaces of the ventilated mats 120 of FIG. 6. A space is located between the ventilated mat system 100 and the underlying infiltration field 260, this space may comprise treatment media or other material. This media or other material may be compacted so as to provide support for the ventilated mat system 100, which is shown in FIG. 6 as a floating slab or slab-on-grade without footings configuration.

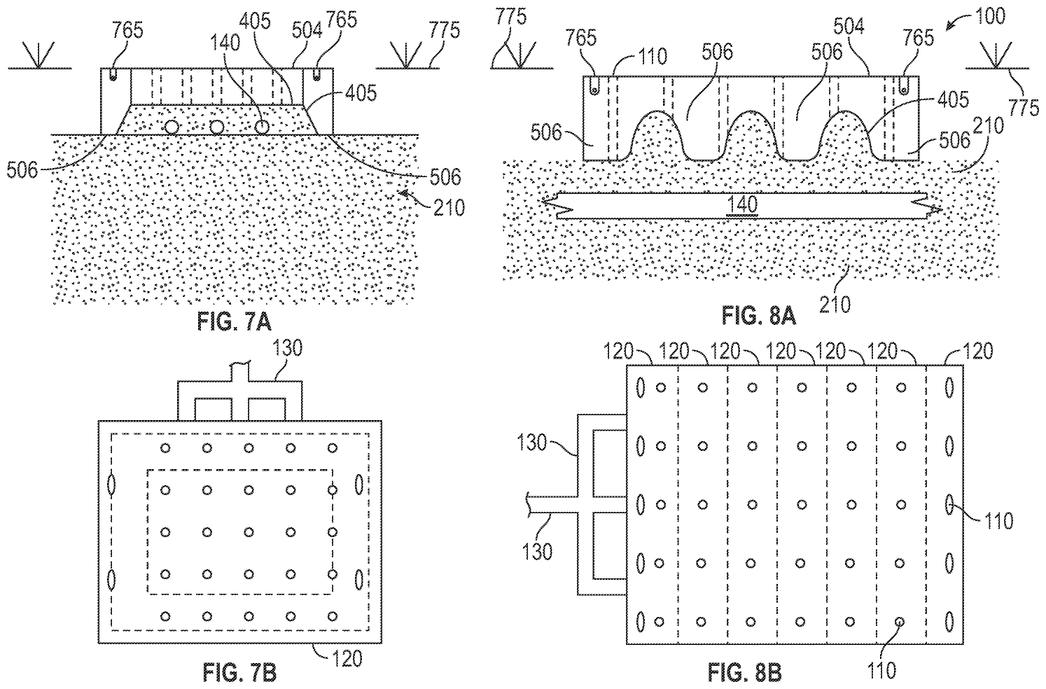

FIG. 7A provides a side view of a ventilated mat system 100 with perimeter footings 506, the ventilated mat system 100 positioned above dosing conduits 140 and treatment media 210, as may be employed in some embodiments. Lifting members 765 are also labelled in FIG. 7A along with bottom surface 405 and surface level 775. The lifting members 765 may be hooks, loops, bolts, chain links, or other members anchored to the ventilated mat system to allow the system to be lifted and placed or otherwise moved during installation. As can be seen in FIG. 7A, the surface level 775 is set approximately even with top surface 504. In embodiments, little or no top soil or other material may be present on top surface 504. The top surface 504 of embodiments may be textured or colored or otherwise configured to blend in with surroundings. For example, the top surface 504 may be black if it is installed with neighboring asphalt or the top surface 504 may be green if grass is nearby. Ventilated aggregate can be placed over the matting and utilized around the area covered with matting to blend in. Markings, such as max vehicular loads, may also be identified on the top surface 504 of ventilated mat systems.

FIG. 7B is a top view of the ventilated mat system 100 of FIG. 7A, as may be employed in some embodiments. The distributions conduits 130 and the ventilated mat 120 are labelled in FIG. 7B. Also visible in FIG. 7B are that the ventilated mat system 100 has a polygonal shape. A single ventilated mat or multiple ventilated mats may be employed in FIGS. 7A-7B.

FIG. 8A provides a side view of a ventilated mat system 100 with multiple footings 506, the ventilated mat system 100 is positioned above dosing conduits 140 and treatment media 210, as may be employed in some embodiments. The footings 50 are formed between the bottom surface 405, which is shaped as multiple arches. The arches and footings may be oriented in embodiments parallel with the dosing conduits, perpendicular to the dosing conduits, and at other orientations as well. In FIG. 8A the space between the footings and the dosing conduits is filled with treatment media. Passages 110 are also labelled in FIG. 8A.

FIG. 8B is a top view of the ventilated mat system 100 of FIG. 8A, as may be employed in some embodiments. As can be seen, seven ventilated mats 120 comprise the ventilated mat system 100 of FIG. 8A. These ventilated mats may have a single row of passages as well as multiple rows of passages. The ventilated mats 120 may be joined by various joint configurations, including those taught in FIG. 11 as well as other configurations. Distribution conduits 130, which sit below the ventilated mat system 100 are also labelled in FIG. 8B.

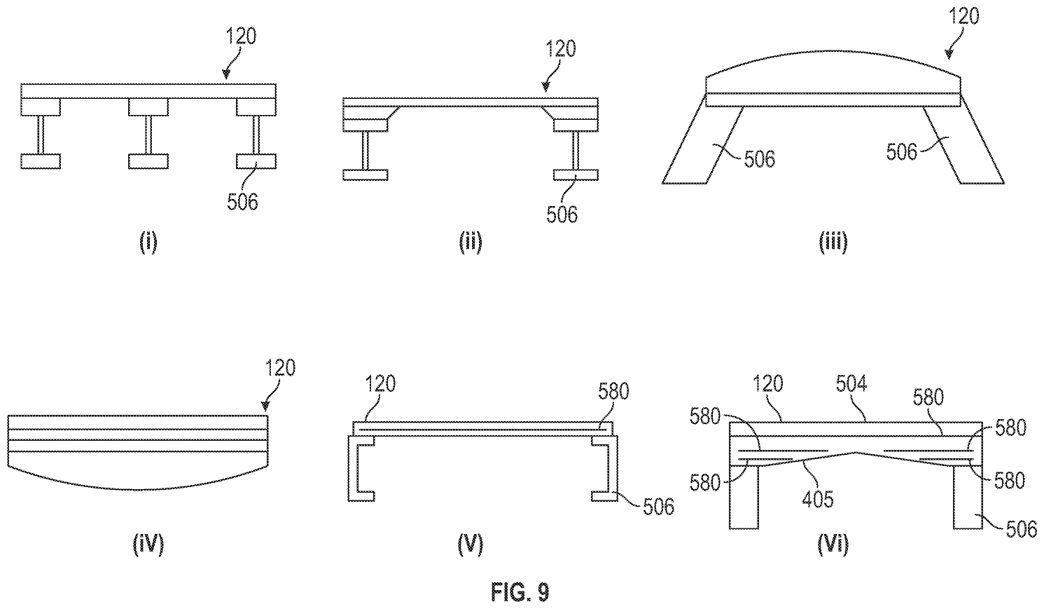

FIG. 9 provides multiple side views of ventilated mat systems as may be employed in some embodiments. Various footing configurations are shown in FIG. 9. Various ventilated mat configurations are shown as well. FIG. 9 at (i) shows three I-beam style footings supporting a plate style ventilated mat. FIG. 9 at (ii) shows perimeter I-beam style footings with a multilayer plate style ventilated mat and additional prisms positioned above the I-beams. FIG. 9 at (iii) shows angle parallelepiped footings supporting a multilayer ventilated mat with a lower flat layer and an upper dome layer. FIG. 9 at (iv) shows a multilayer ventilated mat with a lower inverted dome layer and three planar layers above it and no footings. FIG. 9 at (v) shows two C-channel type footings 506 at the edges of an upper planar ventilated mat, the ventilated mat having internal reinforcement 580. FIG. 9 at (vi) shows a ventilated mat 120 with multiple layers of reinforcement 580 and having a bottom surface with angled surfaces that are not parallel to top surface 504.

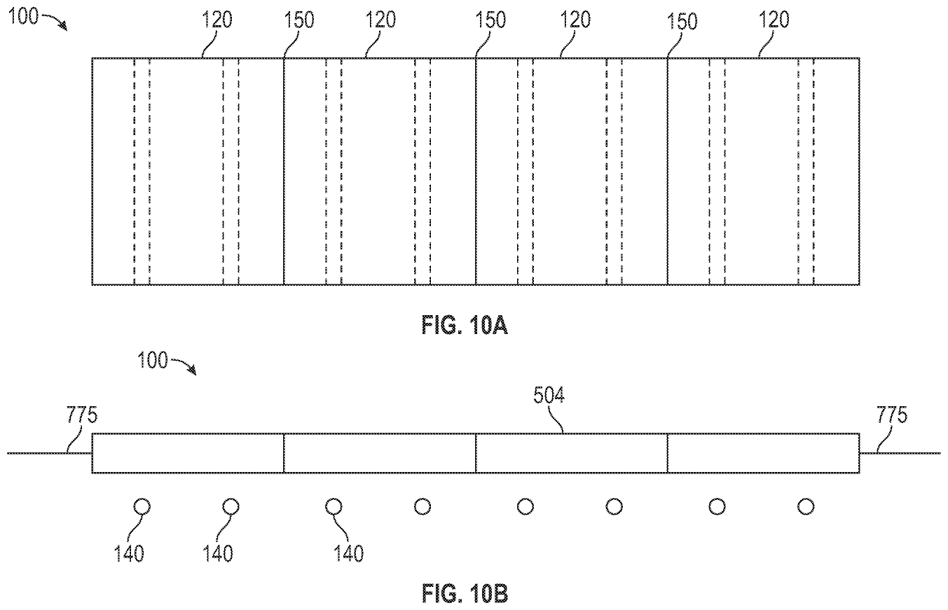

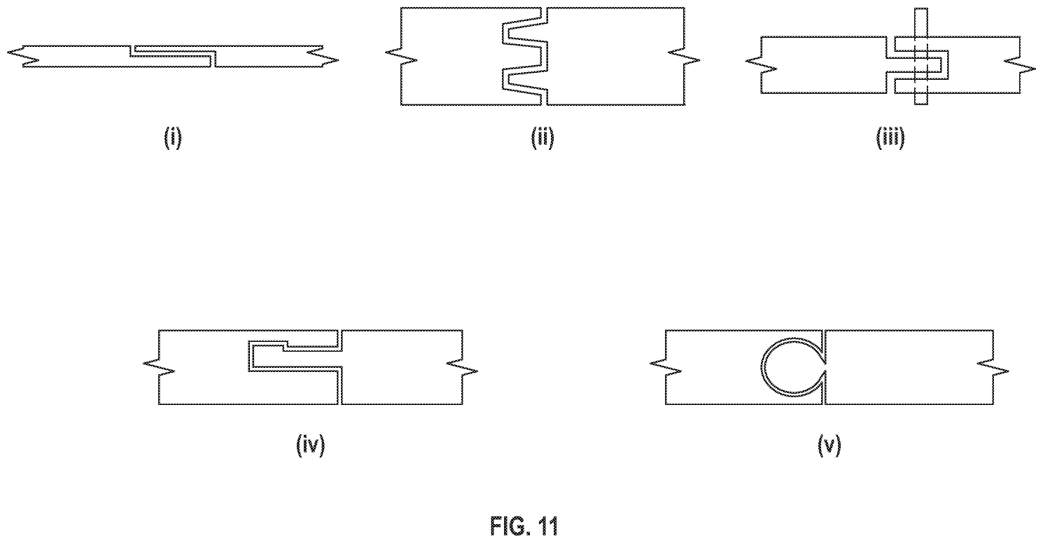

FIG. 10A provides a top view schematic of a ventilated mat system 100, the ventilated mat system with a plurality of passages therethrough, the ventilated mat system positioned atop of dosing conduits of a subsurface infiltration field of a water treatment system, as may be employed in some embodiments. The ventilated mats 120 have joints 150 along adjacent sides.

FIG. 10B provides a side of the ventilated mat system 100 of FIG. 10A, with underlying dosing conduits 140, as may be employed in some embodiments. The adjacent surface level 775 is shown in FIG. 10B. The top surface 504 is higher than the adjacent surface level 775 in FIG. 10B. In embodiments adjacent surface levels may be higher or lower than a top surface of a ventilated mat system. These height differences may be employed to manage surface storm water flow.

FIG. 11 provides various linking configurations for adjacent individual ventilated mats of a ventilated mat system as may be employed in some embodiments. The following joints are shown in FIG. 11: (i) lap joint; (ii) opposing teeth and grooves; (iii) mortise and tenon with pin; (iv) keyed; and (v) pivoting arch and vault.

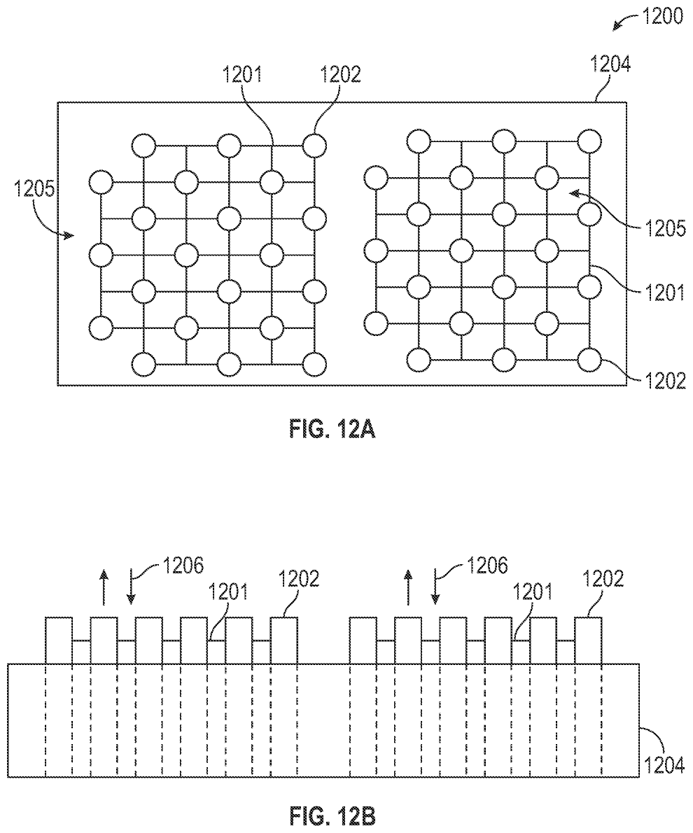

FIG. 12A provides a top view of a ventilated mat form system 1200 as may be employed in some embodiments. The form system 1200 is shown with an outer form 1204 and removable inner forms 1205. The inner forms 1205 comprise connectors 1201 and passage forms 1202. In use, the outer form 1204 may be placed where a ventilated mat system is to be installed, the inner forms 1205 may be placed as well. Once both are placed, concrete may be placed within the outer form and outside of the passage forms 1202. Once the concrete has sufficiently cured, the forms may be removed.

FIG. 12B provides a side view of the ventilated mat form system of FIG. 12A, as may be employed in some embodiments. Arrows 1206 indicate that the passage forms 1205 may be placed and removed from the outer form 1204.

FIG. 13 provides top and side views of a ventilated mat system with elongated rails as may be employed in some embodiments. FIG. 13 at (A) provides a top view while FIG. 13(B) provides a side view when viewed from arrow (B) and FIG. 13 at (C) provides a side view when viewed from arrow (C). The water treatment system 100 in FIG. 13 is shown with elongated rails 1350 functioning as the ventilated mats of other embodiments. These elongated rails 1350 may be spaced a distance apart so as to prevent vehicle tires from falling between adjacent rails. The elongated rails may be 1″-3″ or more or less spaced apart from each other. The elongated rails may comprise metal, or other rigid material with sufficient strength to support vehicular loading. Dosing conduits 140 are shown below the elongated rails 1350. These dosing conduits are shown with oblong cross sections in FIG. 13 at (C). The elongated rails 1350 are shown with elongated cross sections at FIG. 13 at (B). Treatment media 210 and supporting material 1380 are also labelled in FIG. 13. The supporting material may be measured so as to support the ends of the elongated rails resting thereon with little to no settlement or compaction. Base plates or other force spreading components may be placed between the ends of the elongated rails and the supporting material so as to provide extra force dispersion and potentially reduce compaction or settlement of the elongated rails downward and into the supporting material.

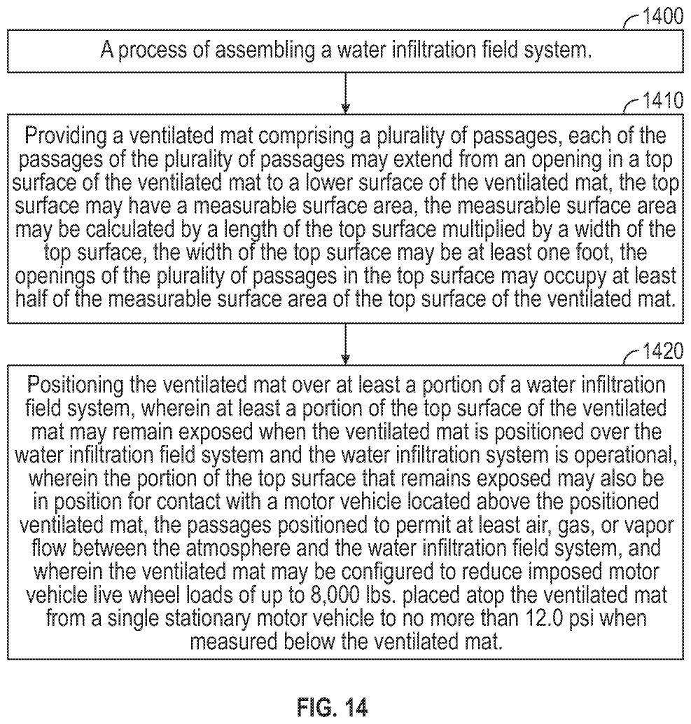

FIG. 14 provides a process chart with process features as may be employed in some embodiments. FIG. 14 at 1400 provides for a process of assembling a water infiltration field system. FIG. 14 at 1410 provides for a ventilated mat comprising a plurality of passages, each of the passages of the plurality of passages may extend from an opening in a top surface of the ventilated mat to a lower surface of the ventilated mat, the top surface may have a measurable surface area, the measurable surface area may be calculated by a length of the top surface multiplied by a width of the top surface, the width of the top surface may be at least one foot, the openings of the plurality of passages in the top surface may occupy at least half of the measurable surface area of the top surface of the ventilated mat. And FIG. 14 at 1420 provides for positioning the ventilated mat over at least a portion of a water infiltration field system, wherein at least a portion of the top surface of the ventilated mat may remain exposed when the ventilated mat is positioned over the water infiltration field system and the water infiltration system is operational, wherein the portion of the top surface that may remain exposed may also be in position for contact with a motor vehicle located above the positioned ventilated mat. In some embodiments stone may be positioned above the ventilated mat and may provide sufficient air and vapor flow to exist. In some embodiments, the passages may be positioned to permit at least air, gas, or vapor flow between the atmosphere and the water infiltration field system, and the ventilated mat may be configured to reduce imposed motor vehicle live wheel loads of up to 8,000 lbs. placed atop the ventilated mat from a single stationary motor vehicle to impose no more than 12.0 PSI when measured below the ventilated mat.

Some embodiments may comprise using the ventilated mat processes, systems, articles of manufacture, or apparatus with or in stormwater and wastewater systems that comprise: a processing/treatment vessel; a distribution system; and an infiltration system comprising an infiltration field, monitoring ports, and carbon addition ports. Some embodiments may comprise using the ventilated mat processes, systems, articles of manufacture, or apparatus with or in infiltration systems comprising infiltration fields comprised of stone, sand, hollow structures, man-made materials and/or synthetic media including geotextiles. Some embodiments may comprise using the ventilated mat processes, systems, articles of manufacture, or apparatus with or in infiltration systems installed directly in native or imported soils. Some embodiments may comprise using the ventilated mat processes, systems, articles of manufacture, or apparatus with or in stormwater or wastewater systems that include a secondary treatment vessel, such as but not limited to, a treatment unit. Some embodiments may comprise using the ventilated mat processes, systems, articles of manufacture, or apparatus with or in stormwater and wastewater infiltration field(s) with a surface area to void space ratio of approximately <0.5. Surface area to void space ratio may be calculated by various methods such as calculations based on of storage volumes or on calculations based on the dimensions of the infiltration field components, such as channels. Some embodiments may comprise using the ventilated mat processes, systems, articles of manufacture, or apparatus with or in stormwater and wastewater infiltration field(s) with a surface area to void space ratio of >0.5. Surface area to void space ratio may be calculated by various methods such as calculations based on storage volumes or on calculations based on the dimensions of the infiltration system components, such as channels. Some embodiments may comprise using the ventilated mat processes, systems, articles of manufacture, or apparatus with or in infiltration systems that may be surrounded by the following soils:
Sands: silt+ (1.5*clay)<15%
Loamy sands: silt+1.5*clay>=15% and silt+2*clay<30%.
Sandy loams: clay>=7% and clay<20% and sand >52% and silt+2*clay>=30% OR clay<7% and silt<50% and silt+2*clay>=30%)
Loam: clay>=7% and clay<27% and silt>=28% and silt<50% and sand <=52%
Silt Loam: silt>=50% and clay>=12% and clay<27% OR silt>=50% and silt<80% and clay<12%
Silt: silt>=80% and clay<12%.
Sandy Clay Loam: clay>=20% and clay<35% and silt<28% and sand >45%
Clay Loam: clay>=27% and clay<40% and sand >20% and sand <=45%
Silty Clay Loam: clay>=27% and clay<40% and sand <=20%
Sandy Clay: clay>=35% and sand >45%
Silty Clay: clay>=40% and silt>=40%
Clay: clay>=40% and sand <=45% and silt<40%

Some embodiments may comprise using the ventilated mat processes, systems, articles of manufacture, or apparatus with or in stormwater and wastewater systems that have stone, cobbles, gravel, ledge, bedrock, or soil parent material as the native material surrounding the system. Some embodiments may comprise using the ventilated mat processes, systems, articles of manufacture, or apparatus with or in stormwater and wastewater systems that have engineered media, such as specified sand or gravel/stone, as the material surrounding the system. Some embodiments may comprise using the ventilated mat processes, systems, articles of manufacture, or apparatus with or in stormwater or wastewater systems that include passive remediation infrastructure including, but not limited to, a constructed wetland, sand filters, gravel filters, waste stabilizing pond/lagoon, collection basin, rain garden, retention/detention areas, vegetated or dry swales, or underground detention systems. Some embodiments may comprise using the ventilated mat processes, systems, articles of manufacture, or apparatus with or in stormwater or wastewater systems that include vegetation pollutant removal, such as, but not limited to, rain gardens, bioswales, and evapotranspiration systems driven by such species as Salix or Phragmites. Some embodiments may comprise using the ventilated mat processes, systems, articles of manufacture, or apparatus with or in stormwater and wastewater systems that are covered with sand, imported or native soil. Some embodiments may comprise using the ventilated mat processes, systems, articles of manufacture, or apparatus with or in stormwater and wastewater systems that are covered with ventilated or unventilated asphalt/pavement. Some embodiments may comprise using the ventilated mat processes, systems, articles of manufacture, or apparatus with or in stormwater and wastewater systems that open to the atmosphere. Some embodiments may comprise using the ventilated mat processes, systems, articles of manufacture, or apparatus with or in stormwater and wastewater systems that are located above grade.

Some embodiments may comprise using the ventilated mat processes, systems, articles of manufacture, or apparatus with or in wastewater systems that serve single residences, multi-family residences, commercial businesses, public organizations/property, private organizations/property, government buildings, and any other situation where onsite wastewater treatment or storm water management is used.

Some embodiments may comprise using the ventilated mat processes, systems, articles of manufacture, or apparatus with or in community based onsite wastewater treatment systems and any soil or water-based treatment systems serving as intermediate or final treatment or dispersal for wastewater treatment plants.

Some embodiments may comprise using the ventilated mat processes, systems, articles of manufacture, or apparatus with or in systems that employ a geotextile fabric within and/or around the system. The geotextile fabric may stabilize the sediment during treatment to avoid soil stratification by particle size.

Embodiments may be employed when a system is restricted or failing to treat and disperse wastewater. Embodiments may be employed when a system is overloaded with wastewater/stormwater and/or organic matter, causing low levels of oxygen within an infiltration field (which may occur either or both because microbial decomposition of organic matter consumes oxygen and because the oxygen concentrations in water are many thousands of times lower than oxygen concentrations in air). These situations may occur when a system is heavily used, the infiltration field is relatively undersized, or if there is an addition of materials to the system that are noncompatible with treatment in the infiltration system. Embodiments may be employed when a system is operating normally, or close to normally, and it is desirable to inhibit or prevent restriction or failing.

The preceding detailed description is merely illustrative in nature and is not intended to limit the embodiments of the subject matter of the application or uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Certain embodiment designs may be implemented as a computer process, a computing system or as an article of manufacture such as a computer program product of computer readable media. The computer program product may be a computer storage medium readable by a computer system and encoding computer program instructions for executing a computer process.

While embodiments have been illustrated herein, they are not intended to restrict or limit the scope of the appended claims to such detail. In view of the teachings in this application, additional advantages and modifications will be readily apparent to and appreciated by those having ordinary skill in the art. Accordingly, changes may be made to the above embodiments without departing from the scope of the invention.

The terminology used herein is for the purpose of describing particular embodiments only and is not intended to be limiting of the invention. As used herein, the singular forms “a,” “an” and “the” are intended to include plural forms as well, unless the context clearly indicates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the terms “about” or “approximately” in reference to a recited numeric value, including for example, whole numbers, fractions, and/or percentages, generally indicates that the recited numeric value encompasses a range of numerical values (e.g., +/−5% to 10% of the recited value) that one of ordinary skill in the art would consider equivalent to the recited value (e.g., performing substantially the same function, acting in substantially the same way, and/or having substantially the same result). As used herein, the terms “about” or “approximately” in reference to a recited non-numeric parameter generally indicates that the recited non-numeric parameter encompasses a range of parameters that one of ordinary skill in the art would consider equivalent to the recited parameter (e.g., performing substantially the same function, acting in substantially the same way, and/or having substantially the same result).

Recitation of ranges of values herein are merely intended to serve as a shorthand method of referring individually to each separate value falling within the range, unless otherwise indicated herein, and each separate value is incorporated into the specification as if it were individually recited herein.

“First,” “Second,” etc. As used herein, these terms are used as labels for nouns that they precede, and do not imply any type of ordering (e.g., spatial, temporal, logical, etc.). For example, reference to a “first” item does not necessarily imply that this item is the item in a sequence; instead, the term “first” is used to differentiate this item from another item (e.g., a “second” item).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

“Based On” As used herein, this term is used to describe one or more factors that affect a determination. This term does not foreclose additional factors that may affect a determination. That is, a determination may be solely based on those factors or based, at least in part, on those factors. Consider the phrase “determine A based on B”. While B may be a factor that affects the determination of A, such a phrase does not foreclose the determination of A from also being based on C. In other instances, A may be determined based solely on B.

“Inhibit”—As used herein, inhibit is used to describe a reducing or minimizing effect. When a component or feature is described as inhibiting an action, motion, or condition it may completely prevent the result or outcome or future state completely. Additionally, “inhibit” can also refer to a reduction or lessening of the outcome, performance, and/or effect which might otherwise occur. Accordingly, when a component, element, or feature is referred to as inhibiting a result or state, it need not completely prevent or eliminate the result or state.

“Improve”—As used herein, improve is used to describe an increasing or maximizing effect. When a component or feature is described as improving an action, motion, or condition, it may produce the desired result or outcome or future state completely. Additionally, “improve” can also refer to an increase of the outcome, performance, and/or effect which might otherwise occur. Accordingly, when a component, element, or feature is referred to as improving a result or state, it need not completely produce the desired result or state.

The scope of the present disclosure includes any feature or combination of features disclosed herein (either explicitly or implicitly), or any generalization thereof, regardless of whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

The corresponding structures, material, acts, and equivalents of any means or steps plus function elements in the claims are intended to include any structure, material or act for performing the function in combination with other claimed elements. The description of certain embodiments of the present invention have been presented for purposes of illustration and description, but is not intended to be exhaustive or limited to the invention in the form disclosed. Many modifications and variations will be apparent to those of ordinary skill without departing from the scope and spirit of the invention. These embodiments were chosen and described in order to best explain the principles of the invention and the practical application, and to enable others of ordinary skill in the art to understand the invention for embodiments with various modifications as are suited to the particular use contemplated.

What is claimed is:

1. A process of assembling a water infiltration field system comprising:
providing a ventilated mat,
the ventilated mat comprising a plurality of passages, each of the passages of the plurality of passages extending from an opening in a top surface of the ventilated mat to a lower surface of the ventilated mat,
the top surface having a measurable surface area, the measurable surface area calculated by a length of the top surface multiplied by a width of the top surface, the width of the top surface being at least one foot,
the openings of the plurality of passages in the top surface occupying at least 25% of the measurable surface area of the top surface of the ventilated mat; and
positioning the ventilated mat over at least a portion of a water infiltration field system, the passages positioned to permit at least air, gas, or vapor flow between the atmosphere and the water infiltration field system, and
wherein the ventilated mat is configured to reduce imposed motor vehicle live wheel loads of up to 8,000 lbs. placed atop the ventilated mat from a single stationary motor vehicle to no more than 12.0 PSI when measured below the ventilated mat.

2. The process of claim 1 wherein the ventilated mat comprises reinforced concrete and the passages have upper and lower openings that are different sizes.

3. The process of claim 1 wherein the ventilated mat is configured to reduce imposed motor vehicle live wheel loads of up to 8,000 lbs. placed atop the ventilated mat from a single stationary motor vehicle to no more than 5.0 PSI when measured below the ventilated mat.

4. The process of claim 1 wherein the ventilated mat is configured to reduce imposed motor vehicle live wheel loads of up to 8,000 lbs. placed atop the ventilated mat from a single stationary motor vehicle to no more than 2.0 PSI when measured below the ventilated mat.

5. The process of claim 1 wherein the ventilated mat comprises a polymer and the passages are cylindrical in shape.

6. The process of claim 1 wherein the openings of the plurality of passages in the top surface occupy at least 50% of the measurable surface area of the top surface of the ventilated mat, and
wherein at least a portion of the top surface of the ventilated mat remains exposed when the ventilated mat is positioned over the water infiltration field system and the water infiltration system is operational,
wherein the portion of the top surface that remains exposed is also in position for contact with a motor vehicle located above the positioned ventilated mat.

7. A water infiltration field system assembly process, comprising:
providing a first ventilated mat comprising a first surface and a second surface, the second surface opposite the first surface, the first surface having a width of at least two feet and a length of at least four feet, and a joining surface, the joining surface configured to join with a joining surface of an adjacent second ventilated mat;
placing the first ventilated mat above an infiltration field, the first surface of the first ventilated mat at least partially exposed after placement, the exposed first surface positioned to come in contact with a tire of a motor vehicle,
wherein the first ventilated mat comprising a plurality of air passages, each air passage of the plurality of air passages extending from an opening in the first surface of the first ventilated mat to an opening in the second surface of the first ventilated mat,
wherein the first ventilated mat configured to withstand an axle loading of 16,000 lbs. acting on the first surface and to transfer that load such that the second surface imposes a pressure of no more than 8.0 PSI to the infiltration field.

8. The water infiltration field system assembly process of claim 7 wherein providing a first ventilated mat comprises providing a concrete form, the concrete form comprising a plurality of inner walls shaped to a plurality of passages, the concrete form further comprising an outer wall surrounding the plurality of inner walls.

9. The water infiltration field system assembly process of claim 8 wherein at least some of the plurality of passages are cylindrical in shape or have a conical shape or are elongated or are nonuniform in length.

10. The water infiltration field system assembly process of claim 8 wherein the outer wall is a polygon.

11. A process of constructing a water infiltration system comprising:
placing a ventilated mat over a wastewater infiltration field, the wastewater infiltration field having a width and a length, and a surface area measured as width times length, the surface area being a minimum of sixteen square feet,
wherein the ventilated mat is positioned to receive motor vehicular axle loads up to 32,000 lbs.,
wherein the ventilated mat is sized and shaped to transfer and reduce a downwardly imposed motor vehicle wheel load from above the ventilated mat to a reduced wheel load below the ventilated mat,
wherein the ventilated mat has a plurality of passages positioned to transfer air, gases, or vapor, including water vapor, through the ventilated mat,
wherein each passage of the plurality of passages has an upper opening, the cumulative area of all the upper openings of the passages from the plurality of passages being at least 25% of the surface area of the ventilated mat.

12. The process of claim 11 further comprising placing a free draining traffic rated aggregate over the ventilated mat.

13. The process of claim 11 further comprising placing a free draining traffic rated aggregate in at least some of the passages, wherein the aggregate ranges from ¼ inch to 1 inch (sieve) size.

14. The process of claim 12 wherein the cumulative area of all the upper openings of the passages from the plurality of passages is more than 40% of the surface area of the ventilated mat.

15. The process of claim 11 wherein the ventilated mat is sized and shaped to transfer and reduce a downwardly imposed motor vehicle wheel load of no more than 8,000 lbs., from above the ventilated mat, to a reduced transferred pressure imposed below the ventilated mat of no more than 12.0 PSI below planar portions of the ventilated mat.

16. The process of claim 11 wherein the ventilated mat is sized and shaped to transfer and reduce a downwardly imposed motor vehicle wheel load of no more than 8,000 lbs., from above the ventilated mat, to a reduced transferred pressure imposed below the ventilated mat of no more than 5.0 PSI below planar portions of the ventilated mat.

17. The process of claim 11 wherein the ventilated mat is sized and shaped to transfer and reduce a downwardly imposed motor vehicle wheel load of no more than 8,000 lbs., from above the ventilated mat, to a reduced transferred pressure imposed below the ventilated mat of no more than 2.0 PSI below planar portions of the ventilated mat.

18. The process of claim 11 wherein the ventilated mat is sized and shaped to transfer and reduce a downwardly imposed motor vehicle wheel load from above the ventilated mat to a reduced wheel load below without shear failure of the ventilated mat.

19. The process of claim 11 further comprising placing a soil over the ventilated mat.

20. The process of claim 11 wherein the ventilated mat is sized to span at least the width or at least the length of the wastewater infiltration field.
